(19) United States
(12) Patent Application Publication
(10) Pub. No.: US 2008/0274885 A1
(43) Pub. Date: Nov. 6, 2008

(54) Biodegradable Seed Dressing Formulations

(75) Inventors: Ingrid Martin, Ludwigshafen (DE); Helmut Auweter, Limburgerhof (DE); Rafel Israels, Koln (DE); Peter Dombo, Wiesbaden (DE); Jurgen Jakob, Rodersheim-Gronau (DE); Diego Lopez Casanello, Speyer (DE); Heribert Bohn, Wattenheim (DE)

Correspondence Address: BRINKS, HOFER, GILSON & LIONE, 2801 SLATER ROAD, SUITE 120, MORRISVILLE, NC, 27560, US

(73) Assignee: BASF SE, Ludwigshafen (DE)

(21) Appl. No.: 12/158,179

(22) PCT Filed: Dec. 11, 2006
(86) PCT No.: PCT/EP2006/069523

§ 371 Date: Jun. 19, 2008

(30) Foreign Application Priority Data
Dec. 22, 2005 (EP) 05028144.3

(51) Int. Cl. A01C 1/06; A01N 25/00; A01N 25/32

(52) U.S. Cl. 504/100; 504/358; 504/103

(57) ABSTRACT

The present invention relates to the use of partially aromatic, biodegradable polyesters for dressing seed, to seed dressing formulations comprising partially aromatic, biodegradable polyesters, to a process for their preparation and to their use for dressing seed.

The present invention relates to the use of partially aromatic, biodegradable polyesters for dressing seed, to seed dressing formulations comprising partially aromatic, biodegradable polyesters, to a process for their preparation and to their use for dressing seed.

Environmental factors, such as wind, sun, rain, and also ground water, may cause an unwanted distribution of crop protection agents. As a consequence, the amount of active compound may be reduced such that a later attack by harmful organisms or a later growth of unwanted plants cannot be prevented.

Formulations having a controlled release of active substance avoid this problem by releasing certain amounts of active compound in a delayed manner over a certain period of time.

Here, it is desirable to achieve a release rate which is as efficient as possible.

Furthermore, in the case of dressed seed, abrasion may result in pesticide-comprising dusts being formed. This is disadvantageous when handling the seed.

Moreover, in the case of customary seed dressing formulations, there is frequently a too rapid release of active compound.

Another disadvantage of numerous formulations described in the prior art is the fact that the polymers described therein are not completely biodegradable.

A further problem with the dressing of seed is the fact that the direct contact of the active compound with the seed may have a negative effect on the germination rate of the seed.

Additionally, when dressing seed, the growth of the plants may be adversely effected, depending on the active compound.

Furthermore, it is advantageous for the seed to have good flowability (i.e. simple application of the seed).

Accordingly, it was an object of the present invention to provide a seed dressing formulation where the abrasion is as low as possible, i.e. there is a reduced dust formation of the dressed seed; and/or

there is a positive effect on the germination rate of the seed which may have been adversely affected by using active compounds
and/or
there is a positive effect on the growth of plants from treated seed which may have been adversely affected by the use of active compounds
and/or
there is a controlled release of active compound and/or
which has good flowability.

A further problem may be insufficient biodegradability. In general, biodegradability means that the polyesters are degraded over an appropriate and measurable period of time. Degradation may be hydrolytically and/or oxidatively and may be caused predominantly by the action of microorganisms, such as bacteria, yeasts, fungi and algae. Biodegradability can be determined, for example, by mixing polyesters with compost and storing them for a certain period of time. According to ASTM D 5338, ASTM D 6400 and DIN V 54900, CO₂-free air is, for example, passed through mature compost during composting, and the compost is subjected to a defined temperature program. Here, the biological degradability is defined by the ratio of the net CO₂-release of the sample (after deduction of the CO₂-release by the compost without sample) to the maximum CO₂-release of the sample (calculated from the carbon content of the sample). Plastics are completely biodegradable (according to DIN V 54 900, part 2) when, over a test period of at most 180 days, at least 60% of the organic carbon of the material has been converted into CO₂. In general, biodegradable polyesters show marked signs of degradation such as colonization by fungi, formation of tears and holes, even after a few days of composting. In contrast, chain growth polymers having a C—C backbone, such as, for example, polyethylene, are poorly biodegradable, if at all.

According to current scientific understanding (W. Tanzer, Biologisch abbaubare Polymere [Biodegradable Polymers], Deutscher Verlag für Grundstoffundustrie, Stuttgart, Germany, 2000), the biodegradability of step growth polymers, such as, for example, polyesters, depends on the following factors:
the chemical bonds (esters>ethers>amides>urethanes)
the molar mass (the lower the molar mass the faster the degradation)
the morphology (amorphous polymers are degraded more quickly than crystalline polymers)
the hardness and the glass transition temperature Tg (soft polymers are degraded more quickly than hard polymers)
the hydrophilicity (hydrophilic polymers are degraded more quickly than hydrophobic polymers)

Since these factors also have an effect on polymer properties (such as, for example, good film forming) which are important for the usability in the seed dressing formulations, it was furthermore an object of the present invention to provide seed formulations having a biodegradability which is as high as possible, i.e. virtually complete.

This object was achieved by using a biodegradable, partially aromatic polyester in the seed dressing.

The present invention also comprises the use of a biodegradable, partially aromatic polyester for preparing seed dressing formulations.

The term dressing comprises all processes for treating seed known to the person skilled in the art (for example seed dressing, seed coating and pelleting).

The term “biodegradable, partially aromatic polyester” is meant to comprise all partially aromatic polyesters meeting at least the definition of biodegradability given in DIN V 54900, in particular compostable partially aromatic polyesters, i.e. polyesters which, according to DIN V 54900 are more than 60% biodegradable.

The term “partially aromatic, biodegradable polyester” is, according to the invention, also to be understood as meaning polyester derivatives, such as polyether esters, polyester amides or polyether ester amides. Suitable biodegradable, partially aromatic polyesters include straight-chain polyesters whose chain has not been extended (WO 92/09654). Preference is given to chain-extended and/or branched, partially aromatic polyesters. The latter are known from the applications WO 96/15173 to 15176, 21689 to 21692, 25446, 25448 or from WO 98/12242, which are expressly incorporated herein by way of reference. Also suitable are mixtures of different partially aromatic polyesters, as are blends of partially aromatic polyesters with biopolymers, such as, for example, starch, or with modified biodegradable biopolymers, such as, for example, modified starch, cellulose esters (for example cellulose acetate, cellulose acetate butyrate) or biodegradable synthetic polymers, such as polylactide (for example as EcoPLA® (from Cargill)).

The preferred partially aromatic polyesters include polyesters, herein below also referred to as TA polyesters, constructed from:
A) an acid component of
   a1) 30 to 95 mol % of at least one aliphatic or at least one cycloaliphatic dicarboxylic acid or ester-forming derivatives thereof or mixtures thereof
   a2) 5 to 70 mol % of at least one aromatic dicarboxylic acid or its ester-forming derivative or mixtures thereof and
   a3) 0 to 5 mol % of a sulfonate group-containing compound,
   where the mole percentages of components a1) to a3) add up to 100% and
B) a diol component of at least one C₂- to C₁₂-alkanediol or one C₅- to C₁₀-cycloalkanediol or mixtures thereof
   and, if desired, additionally one or more components selected from
C) a component selected from
   c1) a dihydroxy compound, containing at least one ether function, of the formula I

HO—[(CH₂)ₙ—O]ₘ—H (I)
in which n is 2, 3 or 4 and m is an integer from 2 to 250,
c2) at least one hydroxycarboxylic acid of the formula IIa or IIb

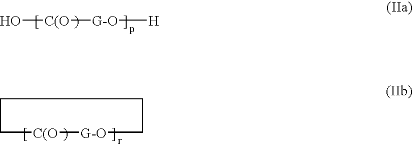

in which p is an integer from 1 to 1500 and r is an integer from 1 to 4 and G is a radical selected from the group consisting of phenylene, —(CH₂)_{q}—, where q is an integer from 1 to 5, —C(R)H— and —C(R)HCH₂, where R is methyl or ethyl
c3) at least one amino-C₂- to C₁₂-alkanol or at least one amino-C₅- to C₁₀-cycloalkanol or mixtures thereof
c4) at least one diamino-C₁- to C₈-alkane
c5) at least one 2,2′-bisoxazoline of the formula III

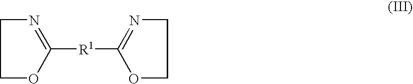

where R¹ is a single bond, a (CH₂)_{z}-alkylene group, where z=2, 3 or 4, or a phenylene group
c6) at least one aminocarboxylic acid selected from the group consisting of natural amino acids, polyamides having a molecular weight of at most 18 000 g/mol, obtainable by polycondensation of a dicarboxylic acid having 4 to 6 carbon atoms and a diamine having 4 to 10 carbon atoms, compounds of the formulae IVa and IVb

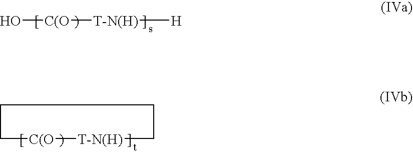

in which s is an integer from 1 to 1500 and t is an integer from 1 to 4 and T is a radical selected from the group consisting of phenylene, —(CH₂)ᵤ—, where u is an integer from 1 to 12, —C(R²)H— and —C(R²)HCH₂, where R² is methyl or ethyl,
and polyoxazolines with the repeat unit V

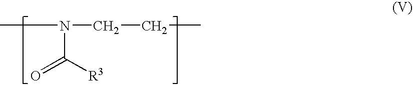

in which R³ is hydrogen, C₁-C₆-alkyl, C₅-C₈-cycloalkyl, phenyl which is unsubstituted or substituted up to three times by C₁-C₄-alkyl groups, or is tetrahydrofuryl,
or mixtures of c1) to c6)
and
D) a component selected from
   d1) at least one compound having at least three groups capable of forming esters
   d2) at least one isocyanate
   d3) at least one divinyl ether
   or mixtures of d1) to d3).

The acid component A of the preferred partially aromatic polyesters comprises from 30 to 70, in particular from 40 to 60, mol % of a1 from 30 to 70, in particular from 40 to 60, mol % of a2.

Suitable aliphatic or cycloaliphatic acids and the corresponding derivatives a1 are the following compounds.

Aliphatic dicarboxylic acids which are suitable according to the invention generally have 2 to 10 carbon atoms, preferably 4 to 6 carbon atoms. They can be either straight-chain or else branched. The cycloaliphatic dicarboxylic acids which can be used in the context of the present invention are generally those having 7 to 10 carbon atoms and in particular those having 8 carbon atoms. However, in principle, it is also possible to use dicarboxylic acids having a relatively large number of carbon atoms, for example up to 30 carbon atoms.

Examples which may be mentioned are: malonic acid, succinic acid, glutaric acid, 2-methylglutaric acid, 3-methylglutaric acid, adipic acid, pimelic acid, acelaic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid and 2,5-norbornanedicarboxylic acid.

Ester-forming derivatives of the aliphatic or cycloaliphatic dicarboxylic acids mentioned above, which may also be used, are in particular the di-C₁- to -C₆-alkyl esters, such as dimethyl, diethyl, di-n-propyl, diisopropyl, di-n-butyl, diisobutyl, di-t-butyl, di-n-pentyl, diisopentyl or di-n-hexyl esters. It is also possible to use anhydrides of the dicarboxylic acids.

Particular preference is given to using adipic acid or sebacic acid, their respective ester-forming derivatives or mixtures thereof. Adipic acid or its ester-forming derivatives, such as its alkyl esters, or mixtures thereof, are employed with particular preference.

Suitable aromatic dicarboxylic acids a2 are, in general, those having 8 to 12 carbon atoms and preferably those having 8 carbon atoms. Terephthalic acid, isophthalic acid, 2,6-naphthoic acid and 1,5-naphthoic acid and ester-forming derivatives thereof may be mentioned by way of example. Particular mention may be made of the di-C₁-C₆-alkyl esters, for example dimethyl, diethyl, di-n-propyl, diisopropyl, di-n-butyl, diisobutyl, di-t-butyl, di-n-pentyl, diisopentyl or di-n-hexyl esters. The anhydrides of the dicarboxylic acids a2 are likewise suitable ester-forming derivatives.

However, in principle, it is also possible to use aromatic dicarboxylic acids a2 having a relatively number of carbon atoms, for example up to 20 carbon atoms.

The aromatic dicarboxylic acids or their ester-forming derivatives a2 can be employed individually or as a mixture of two or more components. Particular preference is given to using terephthalic acid or its ester-forming derivatives, such as dimethyl terephthalate.

The sulfonate group-containing compound used is usually an alkali metal or alkaline earth metal salt of a sulfonate group-containing dicarboxylic acid or its ester-forming derivatives, preferably alkali metal salts of 5-sulfoisophthalic acid or mixtures thereof, particularly preferably the sodium salt.

In a preferred embodiment, the acid component A comprises from 40 to 60 mol % of a1, from 40 to 60 mol % of a2 and from 0 to 2 mol % of a3. In a further preferred embodiment, the acid component A comprises from 40 to 59.9 mol % of a1, from 40 to 59.9 mol % of a2 and from 0.1 to 1 mol % of a3, in particular from 40 to 59.8 mol % of a1, from 40 to 59.8 mol % of a2 and from 0.2 to 0.5 mol % of a3.

The diols B are generally chosen from the group consisting of branched and straight-chain alkanediols having 2 to 12 carbon atoms, preferably 4 to 6 carbon atoms, and cycloalkanediols having 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, in particular ethylene glycol, 1,3-propanediol, 1,4-butanediol and 2,2-dimethyl-1,3-propanediol (neopentyl glycol); cyclopentanediol, 1,4-cyclohexanediol, 1,2-cyclohexanedimethanol, 1,3-cyclohexanedimethanol, 1,4-cyclohexanedimethanol or 2,2,4,4-tetramethyl-1,3-cyclobutanediol. It is also possible to use mixtures of different alkanediols.

Depending on whether an excess of terminal acid or OH groups is desired, either component A or component B may be used in excess. In a preferred embodiment, the molar ratio of the components A to B used is in the range from 0.4:1 to 1.5:1, preferably in the range from 0.6:1 to 1.1:1.

In addition to the components A and B, the TA polyesters may comprise further components.

The dihydroxy compounds c1 used are preferably diethylene glycol, triethylene glycol, polyethylene glycol, polypropylene glycol and polytetrahydrofuran (poly-THF), particularly preferably diethylene glycol, triethylene glycol and polyethylene glycol, where also mixtures thereof or compounds having different variables n (see formula I), for example polyethylene glycol, which contains propylene units (n=3), obtainable for example by polymerization according to methods known per se of initially ethylene oxide and then with propylene oxide, particularly preferably a polymer based on polyethylene glycol, having different variables n, predominantly units formed from ethylene oxide. The molecular weight (Mₙ) of the polyethylene glycol is generally chosen in the range from 250 to 8000, preferably from 600 to 3000, g/mol.

In one of the preferred embodiments, it is possible to use, for example, from 15 to 98, preferably from 60 to 99.5, mol % of the diols B and from 0.2 to 85, preferably from 0.5 to 30, mol % of the dihydroxy compounds c1, based on the molar amount of B and c1, for preparing the TA polyesters.

In a preferred embodiment, the hydroxycarboxylic acid c2) used is: glycolic acid, D-, L-, D,L-lactic acid, 6-hydroxyhexanoic acid, cyclic derivatives thereof, such as glycolid (1,4-dioxane-2,5-dione), D-, L-dilactide (3,6-dimethyl-1,4-dioxane-2,5-dione), p-hydroxybenzoic acid and their oligomers and polymers, such as 3-polyhydroxybutyric acid, polyhydroxyvaleric acid, polylactide (obtainable, for example, as EcoPLA® (from Cargill)) and also a mixture of 3-polyhydroxybutyric acid and polyhydroxyvaleric acid (the latter is obtainable from Zeneca under the name Biopol®); particularly preferred for preparing TA polyesters are the low-molecular-weight and cyclic derivatives thereof.

The hydroxycarboxylic acids can be employed, for example, in amounts of from 0.01 to 50, preferably from 0.1 to 40, % by weight, based on the amount of A and B.

Preferably used as amino-C₂-C₁₂-alkanol or amino-C₅-C₁₀-cycloalkanol (component c3), which is also meant to include 4-aminomethylcyclohexanemethanol, are amino-C₂-C₆-alkanols, such as 2-aminoethanol, 3-aminopropanol, 4-aminobutanol, 5-aminopentanol, 6-aminohexanol, and also amino-C₅-C₆-cycloalkanols, such as aminocyclopentanol and aminocyclohexanol or mixtures thereof.

Preferably used as diamino-C₁-C₈-alkane (component c4) are diamino-C₄-C₆-alkane such as 1,4-diaminobutane, 1,5-diaminopentane and 1,6-diaminohexane (hexamethylenediamine, “HMD”).

In a preferred embodiment, from 0.5 to 99.5 mol %, preferably from 0.5 to 50 mol %, of c3, based on the molar amount of B, and from 0 to 50, preferably from 0 to 35, mol % of c4, based on the molar amount of B, may be used for preparing the TA polyesters.

The 2,2′-bisoxazolines c5 of the formula III are generally obtainable by the process from Angew. Chem. Int. Edit., Vol. 11 (1972), pp. 287-288. Particularly preferred bisoxazolines are those in which R¹ is a single bond, a (CH₂)_{z}-alkylene group where z=2, 3 or 4, such as methylene, ethane-1,2-diyl, propane-1,3-diyl, propane-1,2-diyl, or a phenylene group. 2,2′-bis(2-oxazoline), bis(2-oxazolinyl)methane, 1,2-bis (2-oxazolinyl)ethane, 1,3-bis(2-oxazolinyl)propane or 1,4-bis(2-oxazolinyl)butane, in particular 1,4-bis(2-oxazolinyl)benzene, 1,2-bis(2-oxazolinyl)benzene or 1,3-bis(2-oxazolinyl)benzene, may be mentioned as particularly preferred bisoxazolines.

For preparing the TA polyesters, it is possible to use, for example, from 70 to 98 mol % of B, up to 30 mol % of c3 and from 0.5 to 30 mol % of c4 and from 0.5 to 30 mol % of c5, in each case based on the sum of the molar amounts of the components B, c3, c4 and c5. According to another preferred embodiment, it is possible to use from 0.1 to 5, preferably from 0.2 to 4, % by weight of c5, based on the total weight of A and B.

Natural aminocarboxylic acids may be used as component c6. These include valine, leucine, isoleucine, threonine, methionine, phenylalanine, tryptophan, lysine, alanine, arginine, aspartic acid, cysteine, glutamic acid, glycine, histidine, proline, serine, tyrosine, asparagine or glutamine.

Preferred aminocarboxylic acids of the general formulae IVa and IVb are those in which s is an integer from 1 to 1000 and t is an integer from 1 to 4, preferably 1 or 2, and T is selected from the group consisting of phenylene and —(CH₂)ᵤ—, where u is 1, 5 or 12.

Furthermore, c6 may also be a polyoxazoline of the formula V. However, c6 may also be a mixture of different aminocarboxylic acids and/or polyoxazolines.

In a preferred embodiment, c6 may be used in amounts of from 0.01 to 50, preferably from 0.1 to 40, % by weight, based on the total amount of the components A and B.

Further components which may optionally be used for preparing the TA polyesters include compounds d1 containing at least three groups capable of forming esters.

The compounds d1 preferably contain three to ten functional groups capable of forming ester bonds. Particularly preferred compounds d1 have three to six functional groups of this type in a molecule, in particular three to six hydroxyl groups and/or carboxyl groups. The following may be mentioned by way of example:

tartaric acid, citric acid, malic acid; trimethylolpropane, trimethylolethane; pentaerythritol; polyether triols; glycerols; trimesic acid; trimellitic acid, trimellitic anhydride; pyromellitic acid, pyromellitic dianhydride and hydroxyisophthalic acid.

The compounds d1 are generally employed in amounts of from 0.01 to 15, preferably from 0.05 to 10, particularly preferably from 0.1 to 4, mol %, based on the component A.

An isocyanate or a mixture of different isocyanates is used as component d2. It is possible to use aromatic or aliphatic diisocyanates. However, it is also possible to use more highly functionalized isocyanates.

In the context of the present invention, an aromatic diisocyanate d2 is to be understood as meaning especially toluoylene 2,4-diisocyanate, toluoylene 2,6-diisocyanate, 2,2′-diphenylmethane diisocyanate, 2,4′-diphenylmethane diisocyanate, 4,4′-diphenylmethane diisocyanate, naphthalene 1,5-diisocyanate or xylylene diisocyanate. Among these, 2,2′-, 2,4′- and 4,4′-diphenylmethane diisocyanate are particularly preferred component d2. In general, the latter diisocyanates are used as a mixture.

A suitable tricyclic isocyanate d2 is, for example, tri(4-isocyanophenyl)methane. The polycyclic aromatic diisocyanates are obtained, for example, during the preparation of mono- or bicyclic diisocyanates.

Component d2 may also comprise minor amounts, for example up to 5% by weight, based on the total weight of the component d2, of urethione groups, for example for capping the isocyanate groups.

In the context of the present invention, an alipathic diisocyanate d2 is to be understood as meaning in particular straight-chain or branched alkylene diisocyanates or cycloalkylene diisocyanates having 2 to 20 carbon atoms, preferably 3 to 12 carbon atoms, for example 1,6-hexamethylene diisocyanate, isophorone diisocyanate or methylene-bis(4-isocyanatocyclohexane). Particularly preferred aliphatic diisocyanates d2 are 1,6-hexamethylene diisocyanate and isophorone diisocyanate.

The preferred isocyanurates include aliphatic isocyanurates derived from alkylene diisocyanates or cycloalkylene diisocyanates having 2 to 20 carbon atoms, preferably 3 to 12 carbon atoms, for example isophorone diisocyanate or methylene-bis(4-isocyanatocyclohexane). Here, the alkylene diisocyanates can be either straight-chain or branched. Particular preference is given to isocyanurates based on n-hexamethylene diisocyanate, for example cyclic trimers, pentamers or higher oligomers of n-hexamethylene diisocyanates.

In general, the component d2 is employed in amounts of from 0.01 to 5, preferably from 0.05 to 4, mol %, particularly preferably from 0.1 to 4 mol %, based on the sum of the mole amounts of A and B.

In general, all customary and commercially available divinyl ethers may be used as divinyl ethers d3. Preference is given to using 1,4-butanediol divinyl ether, 1,6-hexanediol divinyl ether or 1,4-cyclohexanedimethanol divinyl ether or mixtures thereof.

The divinyl ethers are preferably employed in amounts of from 0.01 to 5, in particular from 0.2 to 4, % by weight, based on the total weight of A and B.

Examples of preferred TA polyesters are based on the components below

### A, B, d1

### A, B, d2

A, B, d1, d2

### A, B, d3

### A, B, c1

A, B, c1, d3
A, B, c3, c4
A, B, c3, c4, c5
A, B, d1, c3, c5
A, B, c3, d3
A, B, c3, d1
A, B, c1, c3, d3

### A, B, c2

Among these, TA polyesters based on A, B, d1 or A, B, d2 or on A, B, d1, d2 are particularly preferred. In another preferred embodiment, the partially aromatic polyesters are based on A, B, c3, c4, c5 or A, B, d1, c3, c5.

The preparation of the TA polyesters is known per se, for example from WO 96/15173 and WO 04/67632, or can be carried out by methods known per se.

The preferred TA polyesters are characterized by a molecular weight (Mₙ) in the range from 1000 to 100 000, in particular in the range from 9000 to 75 000, g/mol, preferably in the range from 10 000 to 50 000 g/mol, and by a melting point in the range from 60 to 170, preferably in the range from 80 to 150, ° C.

The aliphatic and partially aromatic polyesters mentioned, preferably TA polyesters, can have terminal hydroxyl and/or carboxyl groups in any ratio. The aliphatic and/or partially aromatic polyesters mentioned can also be modified at the terminal groups. Thus, for example, terminal OH groups can be acid-modified by reaction with phthalic acid, phthalic anhydride, trimellitic acid, trimellitic anhydride, pyromellitic acid or pyromellitic anhydride.

Very particular preference is given to TA polyesters a1a2B according to the above definitions in which adipic acid is used as component a1, terephthalic acid is used as component a2 and 1,4-butanediol is used as component B (polybutylene adipate terephthalates, commercially available, for example, as Ecoflex® (BASF)).

In one embodiment of the present invention, it is also possible to use mixtures of TA polyesters with biopolymers, such as, for example, starch, or with modified biodegradable biopolymers, such as, for example modified starch, cellulose esters (for example cellulose acetate, cellulose acetate butyrate) or biodegradable synthetic polymers, such as polylactide (obtainable, for example, as EcoPLA® (from Cargill)).

Hereinbelow, the term “biodegradable, partially aromatic polyester, preferably TA polyester and also mixtures of TA polyesters with biopolymers, such as, for example, starch, or with modified biodegradable biopolymers, such as, for example modified starch, cellulose esters (for example cellulose acetate, cellulose acetate butyrate) or with biodegradable synthetic polymers, such as polylactide (obtainable, for example, as EcoPLA® (from Cargill))” is replaced by the term “polyester according to the invention”. Preferably, the term “polyester according to the invention” describes TA polyesters, mixtures of TA polyesters with polylactic acid, particularly preferably TA polyesters, where the preferences listed in the definition of the TA polyester apply to the TA polyester.

According to the invention, the polyester according to the invention can be employed in the form of a dispersion, preferably an aqueous dispersion.

The polyester dispersions according to the invention may optionally comprise one or more protective colloids and/or one or more emulsifiers for stabilization. Suitable emulsifiers and protective colloids are listed below.

Processes for preparing aqueous polymer dispersions are described, for example, in D. Distler “Wässrige Polymerdispersionen” [“Aqueous polymer dispersions”], Wiley-VCH, Weinheim 1999. In principle, aqueous polymer dispersions can be obtained directly by emulsion polymerization. However, it is also possible to dissolve any soluble polymers in solvents, to emulsify the solutions in water and then to remove the solvent to obtain aqueous dispersions. These are referred to as secondary dispersions since the polymer is prepared beforehand, in a separate step.

Such processes are known to the person skilled in the art.

Thus, for example, processes for preparing corresponding aqueous dispersions of polyesters according to the invention are known from WO 98/12245.

In a preferred embodiment, the process for preparing the secondary dispersion of polyesters according to the invention comprises

(a) dissolving the polyester in an organic solvent and
(b) bringing the solution resulting from (a) into contact with water and
(c) removing the organic solvent after mixing.

The mixing described in step (b) can be carried out batch-wise or, preferably, continuously. To obtain the smallest possible particle or droplet sizes during mixing, a high input of mechanical energy during mixing is recommended. Such an energy input may be achieved, for example, by vigorous stirring or shaking in a suitable apparatus.

In a preferred embodiment of the process mentioned above, the mixing described in step (b) is carried out by injecting the appropriate solutions into a mixing chamber. Such a mixing operation is known to the person skilled in the art and described, for example, in WO 00/33820.

In a preferred embodiment of the abovementioned process, in step (b) an aqueous solution of one or more protective colloids and/or one or more emulsifiers is used instead of water.

It is also possible to use, instead of water, mixtures of water with water-miscible auxiliaries, such as glycols and glycerol, in step (b) of the process mentioned above. Preference is given to using water.

Suitable organic solvents are both solvents miscible with water and water-immiscible solvents.

The term “water-immiscible organic solvent” describes organic solvents having a solubility in water of less than 10%, in a preferred embodiment less than 5%. The boiling point under normal conditions (1 bar of pressure, 20° C.) is preferably 0-100° C. The following solvents may be mentioned by way of example, but not by way of limitation: cyclohexane, cyclopentane, pentane, hexane, heptane, 2-methylpentane, 3-methylpentane, 2-methylhexane, 3-methylhexane, 2-methylbutane, 2,3-dimethylbutane, methylcyclopentane, methylcyclohexane, 2,3-dimethylpentane, 2,4-dimethylpentane, benzene, 1-pentene, 2-pentene, 1-hexene, 1-heptene, cyclohexene, 1-butanol, ethyl vinyl ether, propyl ether, isopropyl ether, butyl vinyl ether, butyl ethyl ether, 1,2-epoxybutane, furan, tetrahydropyran, 1-butanal, 2-methylpropanal, 2-pentanone, 3-pentanone, cyclohexanone, fluoobenzene, hexafluorobenzene, ethyl formate, propyl formate, isopropyl formate, ethyl acetate, vinyl acetate, isopropyl acetate, ethyl propionate, methyl acrylate, ethyl acrylate, methyl methacrylate, chloroethane, 1-chloropropane, 2-chloropropane, 1-chlorobutane, 2-chlorobutane, 1-chloro-2-methylpropane, 2-chloro-2-methylpropane, 1-chloro-3-methylbutane, 3-chloropropene, dichloromethane, trichloromethane, carbon tetrachloride, 1,1-dichloroethane, 1,2-dichloroethane, 1,2-dichloropropane, 1,1,1-trichloroethane, 1,1-dichloroethylene, 1,2-dichloroethylene, trichloroethylene, bromomethane, 1-bromopropane, 2-bromopropane, 1-bromobutane, 2-bromobutane, 2-bromo-2-methylpropane, bromomethylene, iodomethane, iodoethane, 2-iodopropane, trichlorofluoromethane, dichlorofluoromethane, dibromofluoromethane, bromochloromethane, bromochlorofluoromethane, 1,1,2-trichloro-1,2,2-trifluoroethane, 1,1,2,2-tetrachlorodifluoroethane, 1,2-dibromotetrafluoroethane, 1,2-dibromo-1,1-difluoroethane, 1,1-dichloro-2,2-difluoroethylene, propionitrile, acrylonitrile, methacrylonitrile, triethylamine, carbon disulfide, 1-butanethiol, methyl sulfide, ethyl sulfide and tetramethylsilane.

The term “water-miscible organic solvent” describes organic water-miscible solvents which are volatile and thermally stable and only contain carbon, hydrogen, oxygen, nitrogen and sulfur. Expediently, under normal conditions (1 bar of pressure, 20° C.), they are miscible to at least 10% by weight with water and have a boiling point below 200° C., preferably below 100° C., and/or have less than 10 carbon atoms.

Preference is given to appropriate alcohols, esters, ketones, ethers and acetals. Use is made in particular of ethanol, n-propanol, isopropanol, butyl acetate, ethyl acetate, tetrahydrofuran, acetone, 1,2-propanediol 1-n-propyl ether or 1,2-butanediol 1-methyl ether. Very particular preference is given to ethanol, isopropanol, tetrahydrofuran and acetone.

When water-miscible solvents are used, mixing with the aqueous phase in step (b) reduces the solvent quality, resulting in the precipitation of the polyester particles.

If water-immiscible solvents, such as, for example, methylene chloride, cyclohexane or ethyl acetate are used, mixing in step (b) yields an emulsion from which the polyester particles are precipitated during the subsequent evaporation of the solvent, by over saturation of the solution.

The removal of the solvent in step c) of the process mentioned above can be carried out by methods known to a person skilled in the art, such as, for example, distillation, if appropriate under reduced pressure.

The aqueous dispersions, obtained by the process mentioned above, of a polyester according to the invention have a solids content of 1-70%, preferably of 10-30%. The mean particle sizes, which can be determined by quasi-elastic light scattering, of the polyester particles according to the invention in the aqueous dispersions obtained by the process mentioned above are 10 nm-5000 nm, preferably 50 nm-500 nm.

The present invention also claims aqueous dispersions of a polyester according to the invention, preparable by the process mentioned above.

Furthermore, the present invention comprises seed dressing formulations comprising
(1) a polyester according to the invention,
(2) at least one agrochemically active compound suitable for dressing seed, where the active compound is present in solid particles of a size between 0.1 μm and 10 μm; and
(3) a solvent.

Here, the term “agrochemically active compound” (2) refers to at least one active compound selected from the group of the insecticides, fungicides, herbicides and/or safeners, growth regulators (see Pesticide Manual, 13th Ed. (2003)) being used.

Possible active compounds are shown in the list of insecticides below, but this list is not meant to be exhaustive:

organo(thio)phosphates, such as acephate, azamethiphos, azinphos-methyl, chlorpyrifos, chlorpyriphos-methyl, chlorfenvinphos, diazinon, dichlorphos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, triazophos, trichlorfon;
carbamates, such as alanycarb, benfuracarb, bendiocarb, carbaryl, carbosulfan, fenoxycarb, furathiocarb, indoxacarb, methiocarb, methomyl, oxamyl, pirimicarb, propoxur, thiodicarb, triazamate;
pyrethroids such as allethrin, bifenthrin, cyfluthrin, cyphenothrin, cypermethrin and the alpha-, beta-, theta- and zeta-isomers, deltamethrin, esfenvalerate, ethofenprox, fenpropathrin, fenvalerate, cyhalothrin, lambda-cyhalothrin,
imiprothrin, permethrin, prallethrin, pyrethrin I, pyrethrin II, silafluofen, tau-fluvalinate, tefluthrin, tetramethrin, tralomethrin, transfluthrin, zeta-cypermethrin;
arthropod growth regulators, such as
a) chitin synthesis inhibitors; for example benzoylureas, such as chlorofluazuron, cyromacin, diflubenzuron, flucycloxuron, flufenoxuron, hexaflumuron, lufenuron, novaluron, teflubenzuron, triflumuron; buprofezin, diofenolan, hexythiazox, etoxazole, clofentazine;
b) ecdysone antagonists, such as halofenozide, methoxyfenozide, tebufenozide;
c) juvenoids, such as pyriproxyfen, methoprene, fenoxycarb;
d) lipid biosynthesis inhibitors, such as spirodiclofen;
neonicotinoids, such as flonicamid, clothianidin, dinotefuran, imidacloprid, thiamethoxam, nitenpyram, nithiazine, acetamiprid, thiacloprid;
pyrazol insecticides, such as acetoprole, ethiprole, fipronil, tebufenpyrad, tolfenpyrad and vaniliprole; furthermore abamectin, acequinocyl, amitraz, azadirachtin, bifenazate, cartap, chlorfenapyr, chlordimeform, cyromazine, diafenthiuron, diofenolan, emamectin, endosulfan, fenazaquin, formetanate, formetanate hydrochloride, hydramethylnon, indoxacarb, piperonyl butoxide, pyridaben, pymetrozine, spinosad, thiamethoxam, thiocyclam, pyridalyl, pyridalyl, flonicamid, fluacypyrim, milbemectin, spiromesifen, flupyrazofos, NC 512, tolfenpyrad, flubendiamide, bistrifluoron, benclothiaz, pyrafluprole, pyriprole, amidoflumet, flufenerim, cyflumetofen, acequinocyl, lepimectin, profluthrin, dimefluthrin, metaflumizone, N—R′-2,2-dihalo-1-R″-cyclopropanecarboxamide-2-(2,6-dichloro-α,α,α,α-trifluoro-p-tolyl)hydrazone or N—R′-2,2-di(R′″)propionamide-2-(2,6-dichloro-α,α,α,α-trifluoro-p-tolyl)hydrazone, where R′ is methyl or ethyl, halo is chlorine or bromine, R″ is hydrogen or methyl and R′″ is methyl or ethyl, carboxylic diesters of the formula below

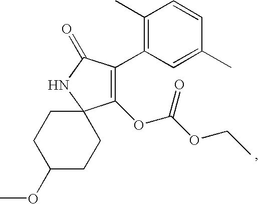

carbonic acid 3-(2,5-dimethylphenyl)-8-methoxy-2-oxo-1-aza-spiro[4.5]dec-3-en-4-yl ester ethyl ester

Aminoisothiazole of the formula

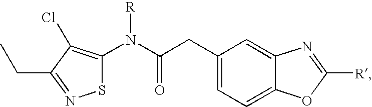

in which

### R=CH₂OCH₃ or H and

### R′=—CF₂CF₂CF₃;

Anthranilamides of the formula

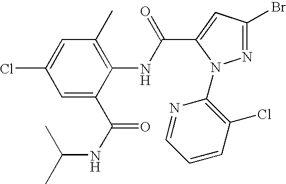

### N-(4-chloro-2-isopropylcarbamoyl-6-methylphenyl)-5-bromo-2-(3-chloropyridin-2-yl)-2H-pyrazole-3-carboxamide

The list of fungicides below shows possible active compounds, but is not meant to be limited to these:

1. Strobilurins, such as
azoxystrobin, dimoxystrobin, enestrostrobin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)-ethyl]benzyl)carbamate, methyl 2-(ortho-(2,5-dimethylphenyloxymethylene)phenyl)-3-methoxyacrylate.
2. Carboxamides, such as
carboxanilides: benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(2-cyanophenyl)-3,4-dichloroisothiazole-5-carboxamide; carboxylic acid morpholides: dimethomorph, flumorph;
benzamides: flumetover, fluopicolide (picobenzamid), zoxamide;
other carboxamides: carpropamid, diclocymet, mandipropamid, N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methylbutyramide;
3. Azoles, such as
triazoles: bitertanol, bromuconazole, cyproconazole, difenoconazole, diniconazole, nilconazole, epoxiconazole, fenbuconazole, flusilazole, e, flutriafol, hexaconazole, imibenconazole, ipconazole, metconazole, myclobufluquinconazoltanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazole;
4. Nitrogenous heterocyclyl compounds, such as
pyridines: fluazinam, pyrifenox, 3-[5-(4-chlorophenyl)-2,3-dimethylisoxazolidin-3-yl]-pyridine;
pyrimidines: bupirimate, cyprodinil, ferimzone, fenarimol, mepanipyrim, nuarimol, pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozolin;
others: acibenzolar-5-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole, 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazole-1-sulfonamide;
5. Carbamates and dithiocarbamates, such as
dithiocarbamates: ferbam, mancozeb, maneb, metiram, metam, propineb, thiram, zineb, ziram;
carbamates: diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;
6. Other fungicides, such as
guanidines: dodine, iminoctadine, guazatine;
antibiotics: kasugamycin, polyoxins, streptomycin, validamycin A;
organometallic compounds: fentin salts;
sulfur-containing heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate-methyl, chlorothalonil, dichlorfluanid, tolylfluanid, flusulfamide, phthalide, hexachlorobenzene, pencycuron, quintozene;
nitrophenyl derivatives: binapacryl, dinocap, dinobuton;
inorganic active compounds: Bordeaux mixture, copper acetate, copper hydroxide, copper oxychloride, basic copper sulfate, sulfur;
others: spiroxamine, cyflufenamid, cymoxanil, metrafenone.

If the active compound used is a herbicide, it is also possible to use the seed of transgenic plants or plants obtained by customary breeding methods.

Thus, it is possible to use seed which is tolerant to herbicides, for example plants which are resistant to sulfonylureas, imidazolinones or glufosinate or glyphosate (see, for example, EP-A-0242236, EP-A-242246) (WO 92/00377) (EP-A-0257993, U.S. Pat. No. 5,013,659).

In a preferred embodiment, the agrochemically active compound is selected from the group of the fungicides and/or insecticides.

Preferred fungicides are
strobilurins, preferably kresoxim-methyl, pyraclostrobin, oryzastrobin carboxanilides, preferably boscalid, and azoles, preferably epoxiconazole, prothioconazole, tebuconazole, and triticonazole, fluquinconazole and also spiroxamine

Particular preference is given to triticonazole and fluquinconazole.

Very particular preference is given to triticonazole.

Preferred insecticides are pyrazole insecticides, preferably fipronil, pyrethroids, preferably alpha-cypermethrin, neonicotinoids, such as flonicamid, clothianidin, dinotefuran, imidacloprid, thiamethoxam, nitenpyram, nithiazine, acetamiprid and thiacloprid; the preferred neonicotinoid is imidacloprid. A very particularly preferred insecticide is fipronil.

The seed dressing formulations according to the invention comprise 1-30% by weight, preferably 5-20% by weight, of polyester and 1-60% by weight, preferably 1-30% by weight, of agrochemically active compound.

For the treatment of seed, the corresponding formulations having a high concentration of active compound can also be diluted by a factor of 2 to 10.

Furthermore, the seed dressing formulations according to the invention may comprise further formulation auxiliaries. These auxiliaries can usually be present in the seed dressing formulations according to the invention in an amount of from 0.1 to 40% by weight, preferably from 5 to 20% by weight.

The remainder to 100% is made up using a solvent.

The term formulation auxiliaries describes surfactants (such as wetting agents, emulsifiers, tackifiers or dispersants or protective colloids), antifoams, thickeners, antifreeze agents, adhesives and also bactericides.

Surfactants which may be present in the seed dressing formulations according to the invention are all surfactants customary for formulating agrochemically active compounds, i.e. in the present case all water-soluble polymers having amphiphilic character known to the person skilled in the art, such as, for example, proteins, denatured proteins, polysaccharides, hydrophobically modified starches, and synthetic polymers, preferably polyvinyl alcohol, polycarboxylates, polyalkoxylates, polyvinylamine, polyethyleneimine, polyvinylpyrrolidone and copolymers thereof. These compounds are particularly suitable as protective colloids.

Examples of further surfactants which may be present in the formulations according to the invention are customary nonionic, anionic and/or cationic dispersants/wetting agents, such as alkali metal, alkaline earth metal and ammonium salts of lignosulfonic acid, naphthalenesulfonic acid, phenolsulfonic acid, dibutylnaphthalenesulfonic acid, alkylarylsulfonates, alkylphenyl ether sulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene and of naphthalenesulfonic acid with phenol and formaldehyde, polyoxyethylene octylphenol ether, ethoxyated isooctyl phenol, octyl phenol, nonyl phenol, alkyl phenol polyglycol ethers, tributyl phenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sucrose esters, sorbitol esters, lignosulfite waste liquors and methylcellulose.

The importance and the appropriate use of the compositions mentioned above depends on the nature of the active compound.

Thickeners which may be present in the formulations according to the invention are all thickeners customary for formulating agrochemically active compounds. Examples of thickeners (i.e. compounds which bestow upon the formulation pseudo plastic flow properties, i.e. high viscosity at rest and low viscosity in the agitated state) are, for example polysaccharides and organic sheet minerals, such as xanthan gum (Kelzan® from Kelco), Rhodopol®) 23 (Rhone Poulenc) or Veegum® (from R.T. Vanderbilt) or Attaclay® (from Engelhardt).

Antifoams which may be present in the formulations according to the invention are all antifoams customary for formulating agrochemically active compounds. Examples of antifoams are silicone emulsions (such as, for example, Silikon® SRE, from Wacker or Rhodorsil® from Rhodia), long-chain alcohols, fatty acids, organofluorine compounds and mixtures thereof.

It is possible to add bactericides to stabilize the aqueous fungicide formulation. Bactericides which may be present in the formulations according to the invention are all bactericides customary for formulating agrochemically active compounds, such as, for example, bactericides based on dichlorophene and benzyl alcohol hemiformal. Examples of bactericides are Proxel® from ICI or Acticide® RS from Thor Chemie and Kathon® MK from Rohm & Haas.

Antifreeze agents which may be present in the formulations according to the invention are all antifreeze agents customary for formulating agrochemically active compounds. Suitable antifreeze agents are, for example, ethylene glycol, propylene glycol or glycerol, preferably propylene glycol and glycerol.

Suitable solvents are water and mixtures of water with water-miscible auxiliaries, such as glycols and glycerol. The preferred solvent is water.

Adhesives which may be present in the seed dressing formulations according to the invention are all binders customarily used in seed dressings. Polyvinylpyrrolidone, polyvinyl acetate, polyvinyl alcohol and Tylose may be mentioned by way of preference.

Furthermore, it is optionally also possible to add colorants to the seed dressing formulations according to the invention. Suitable are all colorants customary for such purposes. Here, it is possible to use both sparingly water-soluble pigments and water-soluble dyes. The dyes known under the names Rhodamin B, C.I. Pigment Red 112 and C.I. Solvent Red 1 may be mentioned as examples, and also Pigment Blue 15:4, Pigment Blue 15:3, Pigment Blue 15:2, Pigment Blue 15:1, Pigment Blue 80, Pigment Yellow 1, Pigment Yellow 13, Pigment Red 112, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108.

The formulations according to the invention can be prepared by methods known to the person skilled in the art (cf. U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pp. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Federal Republic of Germany), 2001).

Here, it is possible to prepare the seed dressing formulation by mixing a suspension of an agrochemically active compound suitable for dressing seed, where the active compound is present in solid particles of a size between 0.1 μm and 10 μm, with an aqueous dispersion of a biodegradable polyester.

Here, the active compound suspension can be prepared, for example, by comminuting the corresponding active compound (s) with addition of surfactants (dispersants and wetting agents) and, if appropriate, further auxiliaries and water or an organic solvent in an agitated ball mill to give a fine suspension of active compound.

Here, the active compound suspension can also be a commercially available suspension formulation of one (or more) agrochemically active compound (for example SC, OD, FS), where the active compound must have the particle sizes given above.

Alternatively, the active compound suspension can also be prepared from a solid formulation (which may be commercially available) of an active compound by dispersion in a solvent, preferably water (for example from a powder formulation (for example WP, SP, SS, WS) or granulate formulation (for example WG, SG)), where, if required, the appropriate particle sizes may be obtained by comminution (for example grinding). The preparation of granulate formulations is known to the person skilled in the art and can be carried out by known methods (cf. U.S. Pat. No. 3,060,084, Browning, “Agglomeration”, Chemical Engineering, Dec. 4, 1967, 147-48, Perry's Chemical Engineer's Handbook, 4th Ed., McGraw-Hill, New York, 1963, pp. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Federal Republic of Germany), 2001).

If required, adhesives and pigments may optionally be added to these suspension formulations.

The present invention furthermore comprises a method for dressing seed, which method is based on using a polyester according to the invention.

In one embodiment of the present invention, the method for dressing seed comprises

(a) treating seed with a seed dressing formulation according to the invention; and
(b) if appropriate, drying the seed obtained in step (a).

Here, the seed dressing formulation according to the invention may—if desired—be diluted with a solvent, preferably water, prior to application to the seed.

In a further embodiment of the present invention, the method for dressing seed comprises treating seed with a dispersion of a partially aromatic polyester according to the invention.

The seed pretreated in this manner can then be treated with an agrochemical suspension formulation comprising at least one agrochemically active compound suitable for dressing seed, where the active compound is present in solid particles having a size between 0.1 μm and 10 μm.

These agrochemical formulations are suspension formulations of one (or more) agrochemically active compound (for example SC, OD, FS), where the active compound must have the particle sizes given above. The preparation of suspension formulations is known to the person skilled in the art and is described further above.

Alternatively, the active compound suspension can also be prepared from a solid formulation (which may also be commercially available) of an active compound by dispersion in a solvent, preferably water (see above).

The term seed comprises seed of all types, such as, for example, grains, seeds, fruits, tubers, seedlings and similar forms. Here, the term seed preferably describes grains and seeds.

Suitable seed is seed of cereals, root crops, oil crops, vegetables, spices, ornamentals, for example seed of durum and other wheat, barley, oats, rye, corn (fodder corn and sugar corn), soybeans, oil crops, crucifers, cotton, sunflowers, bananas, rice, oilseed rape, turnip, sugarbeet, fodder beet, egg plants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, sugar cane, tobacco, grapes, petunias, geranium/pelargoniums, pansies, impatiens. Here, the term seed preferably describes cereal and soybeans.

The seed dressing formulations according to the invention can be used for dressing seed of plants obtained by customary breeding methods and for dressing seed of transgenic plants.

As already mentioned, it is possible to use seed tolerant to herbicides, for example plants resistant to sulfonylureas, imidazolinones or glufosinate or glyphosate (see, for example EP-A-0242236, EP-A-242246) (WO 92/00377) (EP-A-0257993, U.S. Pat. No. 5,013,659), or seed of transgenic plants, for example cotton, which produce Bacillus thuringiensis toxin (Bt toxins) and which are thus resistant to certain harmful organisms (EP-A-0142924, EP-A-0193259).

It is furthermore also possible to use seed of plants which, compared to customary plants, have modified properties. Examples of these are modified starch synthesis (e.g. WO 92/11376, WO 92/14827, WO 91/19806) or fatty acid compositions (WO 91/13972).

What is claimed in the context of the present invention includes seed treated with a polyester according to the invention.

Also claimed is seed treated with a polyester according to the invention which, in a second step, has been treated as described above with a customary suspension formulation.

Also claimed is seed treated with a seed dressing formulation according to the invention.

The application rates are generally between 0.1 g-10 kg of active compound per 100 kg of seed, preferably from 1 g to 5 kg, particularly preferably from 1 g-2.5 kg. For specific seed, such as lettuce, the application rates may also be higher. For soybeans, application rates of 0.1-10 kg are used.

The treatment of seed may be carried out by spraying the seed with the formulation or by mixing the seed with the formulation, if appropriate followed by drying the seed, prior to sowing and prior to germination, according to methods known to the person skilled in the art.

The present invention furthermore comprises a method for regulating the growth of plants and/or for controlling unwanted vegetation and/or for controlling unwanted infestation by insects or mites on plants and/or for controlling phytopathogenic fungi, which comprises treating seed of useful plants with a seed dressing formulation according to the invention.

Preferably, the invention comprises methods for controlling unwanted infestation by insects or mites on plants and/or for controlling phytopathogenic fungi, which comprises treating seed of useful plants with a seed dressing formulation according to the invention.

Control of unwanted vegetation means the control/destruction of plants growing on sites where they are unwanted, for example of

Dicotyledonous plants of the species: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.

Monocotyledonous plants of the species: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemum, Sphenoclea, Dactyloctenium, Agrostis, Alopecurus, Apera.

The term unwanted insects or mites describes the following genera, but is not limited thereto:

Diplopoda or Myriapoda, such as, for example, Blaniulus species,

Ants (Hymenoptera) such as, for example, Atta capiguara, Atta cephalotes, Atta laevigata, Atta robusta, Atta sexdens, Atta texana, Monomorium pharaonis, Solenopsis geminata, Solenopsis invicta, Pogonomyrmex species and Pheidole megacephala,

Beetles (Coleoptera), such as, for example, Agrilus sinuatus, Agriotes lineatus, Agriotes obscurus and other Agriotes species, Amphimallus solstitialis, Anisandrus dispar, Anthonomus grandis, Anthonomus pomorum, Aracanthus morei, Atomaria linearis, Blapstinus species, Blastophagus piniperda, Blitophaga undata, Bothynoderes punciventris, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus and other Conoderus species, Conorhynchus mendicus, Crioceris asparagi, Cylindrocopturus adspersus, Diabrotica (longicornis) barberi, Diabrotica semi-punctata, Diabrotica speciosa, Diabrotica undecimpunctata, Diabrotica virgifera and other Diabrotica species, Eleodes species, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus and other Limonius species, Lissorhoptrus oryzophilus, Listronotus bonariensis, Melanotus communis and other Melanotus species, Meligethes aeneus, Melolontha hippocastani, Melolontha melolontha, Oulema oryzae, Ortiorrhynchus sulcatus, Oryzophagus oryzae, Otiorrhynchus ovatus, Oulema oryzae, Phaedon cochleariae, Phyllotreta chrysocephala, Phyllophaga cuyabana and other Phyllophaga species, Phyllopertha horticola, Phyllotreta nemorum, Phyllotreta striolata, and other Phyllotreta species, Popillia japonica, Promecops carinicollis, Premnotrypes voraz, Psylliodes species, Sitona lineatus, Sitophilus granaria, Sternechus pinguis, Sternechus subsignatus, and Tanymechus palliatus and other Tanymechus species,

Flies (Diptera) such as, for example, Agromyza oryzea, Chrysomya bezziana, Chrysomya hominivorax, Chrysomya macellaria, Contarinia sorghicola, Cordylobia anthropophaga, Dacus cucurbitae, Dacus oleae, Dasineura brassicae, Delia antique, Delia coarctata, Delia platura, Delia radicum, Fannia canicularis, Gasterophilus intestinalis, Geomyza Tripunctata, Glossina morsitans, Haematobia irritans, Haplodiplosis equestris, Hypoderma lineata, Liriomyza sativae, Liriomyza trifolii, Lucilia caprina, Lucilia cuprina, Lucilia sericata, Lycoria pectoralis, Mayetiola destructor, Muscina stabulans, Oestrus ovis, Opomyza florum, Oscinella frit, Pegomya hysocyami, Phorbia antiqua, Phorbia brassicae, Phorbia coarctata, Progonya leyoscianii, Psila rosae, Rhagoletis cerasi, Rhagoletis pomonella, Tabanus bovinus, Tetanops myopaeformis, Tipula oleracea and Tipula paludosa,

Heteropterans (Heteroptera), such as, for example, Acrosternum hilare, Blissus leucopterus, Cicadellidae such as, for example Empoasca fabae, Chrysomelidae, Cyrtopeltis notatus, Delpahcidae, Dysdercus cingulatus, Dysdercus intermedius, Eurygaster integriceps, Euschistus impictiventris, Leptoglossus phyllopus, Lygus lineolaris, Lygus pratensis, Nephotettix species, Nezara viridula, Pentatomidae, Piesma quadrata, Solubea insularis and Thyanta perditor,

Aphids and other homopterans (Homoptera), e.g. Acyrthosiphon onobrychis, Adelges laricis, Aphidula nasturtii, Aphis fabae, Aphis forbesi, Aphis glycines, Aphis gossypii, Aphis grossulariae, Aphis pomi, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes (Myzus) persicae, Myzus ascalonicus, Myzus cerasi, Myzus varians, Nasonovia ribis-nigri, Nilaparvata lugens, Pemphigus bursarius, Pemphigus populivenae, and other Pemphigus species, Perkinsiella saccharicida, Phorodon humuli, Psyllidae, such as, for example Psylla mali, Psylla piri and other Psylla species, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii;

Lepidoptera, for example, Agrotis ypsilon, Agrotis segetum and other Agrotis species, Alabama argillacea, Anticarsia gemmatalis, Argyresthia conjugella, Autographa gamma, Bupalus piniarius, Cacoecia murinana, Capua reticulana, Chematobia brumata, Chilo suppresalis and other Chilo species, Choristoneura fumiferana, Choristoneura occidentalis, Cirphis unipuncta, Cnaphlocrocis medinalis, Cydia pomonella, Dendrolimus pini, Diaphania nitidalis, Diatraea grandiosella, Earias insulana, Elasmopalpus lignosellus, Eupoecilia ambiguella, Euxoa species, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Lerodea eufala, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Momphidae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sesamia nonagrioides and other Sesamia species, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis.

Orthoptera, such as, for example, Acrididae, Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;

Termites (Isoptera), such as, for example, Calotermes flavicollis, Coptotermes species, Dalbulus maidis, Leucotermes flavipes, Macrotermes gilvus, Reticulitermes lucifugus and Termes natalensis;

Thrips (Thysanoptera), such as, for example, Frankliniella fusca, Frankliniella occidentalis, Frankliniella tritici and other Frankliniella species, Scirtothrips citri, Thrips oryzae, Thrips palmi, Thrips simplex and Thrips tabaci,

Arachnids, such as, for example, Acarina, for example of the families Argasidae, Ixodidae and Sarcoptidae, such as, for example, Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae species, such as, for example, Aculus schlechtendali, Phyllocoptrata oleivora and Eriophyes sheldoni; Tarsonemidae species, such as, for example, Phytonemus pallidus and Polyphagotarsonemus latus; Tenuipalpidae species, such as, for example, Brevipalpus phoenicis; Tetranychidae species, such as, for example, Tetranychus cinnabarinus, Tetranychus kanzawai, Tetranychus pacificus, Tetranychus telarius and Tetranychus urticae, Panonychus ulmi, Panonychus citri, and Oligonychus pratensis;

Nematodes, in particular plant-infesting nematodes, such as, for example, root knot nematodes, Meloidogyne hapla, Meloidogyne incognita, Meloidogyne javanica, and other meloidogyne species; cyst-forming nematodes, Globodera rostochiensis and other globodera species; Heterodera avenae, Heterodera glycines, Heterodera schachtii, Heterodera trifolii, and other heterodera species; seed gall nematodes, anguina species; stem and foliar nematodes, aphelenchoides species; sting nematodes, Belonolaimus longicaudatus and other belonolaimus species; pine nematodes, Bursaphelenchus xylophilus and other bursaphelenchus species; ring nematodes, criconema species, criconemella species, criconemoides species, mesocriconema species; stem and bulb nematodes, Ditylenchus destructor, Ditylenchus dipsaci and other ditylenchus species; awl nematodes, dolichodorus species; spiral nematodes, Heliocotylenchus multicinctus and other helicotylenchus species; sheath und sheathoid nematodes, hemicycliophora species and hemicriconemoides species; hirshmanniella species; lance nematodes, hoploaimus species; false rootknot nematodes, nacobbus species; needle nematodes, Longidorus elongatus and other longidorus species; lesion nematodes, Pratylenchus neglectus, Pratylenchus penetrans, Pratylenchus curvitatus, Pratylenchus goodeyi and other Pratylenchus species; burrowing nematodes, Radopholus similis and other radopholus species; reniform nematodes, Rotylenchus robustus and other rotylenchus species; Scutellonema species; stubby root nematodes, Trichodorus primitivus and other trichodorus species, paratrichodorus species; stunt nematodes, Tylenchorhynchus claytoni, tylenchorhynchus dubius and other tylenchorhynchus species; citrus nematodes, tylenchulus species; dagger nematodes, xiphinema species; and other plant parasitic nematode species.

The term phytopathogenic fungi describes the following species, but is not limited thereto:

The term phytopathogenic fungi describes the following species, but is not limited thereto: Alternaria spp. on rice, vegetables, soybeans, oilseed rape, sugarbeet and fruits, Aphanomyces spp. on sugarbeet and vegetables, Bipolaris and Drechslera spp. on corn, cereal, rice and ornamental lawn, Blumeria graminis (powdery mildew) on cereal, Botrytis cinerea (gray mold) on strawberries, vegetable, ornamental flowers, grapevines, Bremia lactucae on lettuce, Cercospora spp. on corn, soybean and sugarbeet, Cochliobolus spp. on corn, cereal, rice (e.g. Cochliobolus sativus on cereal, Cochliobolus miyabeanus on rice), Colletotrichum spp. on soybean and cotton, Drechslera spp. on cereal and corn, Exserohilum spp. on corn, Erysiphe cichoracearum and Sphaerotheca fuliginea on cucumbers, Erysiphe necator on grapevines, Fusarium and Verticillium spp. on various plants, Gaeumannomyces graminis an cereal, Gibberella spp. on cereal and rice (e.g. Gibberella fujikuroi on rice, Gibberella zeae on cereal), Grainstaining complex on rice, Microdochium nivale on cereal, Mycosphaerella spp. on cereal, bananas and peanuts, Phakopsora pachyrhizi and Phakopsora meibomiae on soybeans, Phomopsis spp. on soybeans and sunflowers, Phytophthora infestans on potatoes and tomatoes, Plasmopara viticola on grapevines, Podosphaera leucotricha on apples, Pseudocercosporella herpotrichoides on wheat and barley, Pseudoperonospora spp. on hops and cucumber, Puccinia spp. on cereal and corn, Pyrenophora spp. on cereal, Pyricularia oryzae on rice, Cochliobolus miyabeanus and Corticium sasakii (Rhizoctonia solani), Fusarium semitectum (and/or moniliforme), Cercospora oryzae, Sarocladium oryzae, S attenuatum, Entyloma oryzae, Gibberella fujikuroi (bakanae), Grainstaining complex (various pathogens), Bipolaris spp., Drechslera spp. and Pythium and Rhizoctonia spp. on rice, corn, cotton, sunflower, oilseed rape, oilseed rape, (canola, oilseed rape), vegetable, ornamental lawn, nuts and other plants, Rhizoctonia solani on potatoes, Sclerotinia spp. on oilseed rape species (canola/oilseed rape) and sunflower, Septoria tritici and Stagonospora nodorum on wheat, Uncinula necator on grapevines, Sphacelotheca reiliana on corn, Thievaliopsis spp. on soybeans and cotton, Tilletia spp. on cereals, Ustilago spp. on cereal, corn, sugar cane and, Venturia spp. (scab) on apples and pears.

### EXAMPLES

### Example 1

### Preparation of an Aqueous Dispersion of a Ta Polyester

9.0 g of polybutylene adipate terephthalate (Ecoflex®, BASF AG) were dissolved at room temperature in 1000 g of tetrahydrofuran (solvent phase).

In a separate vessel, 3.3 g of Na caseinate and 2.0 g of Na alkylphenol ether sulfate (Lutensit A-ES®, BASF AG) were dissolved in 10 liters of deionized water (aqueous phase).

To precipitate the polybutylene adipate terephthalate, the solvent phase, at a pump rate of 3.19 kg/h and a temperature of 95.9° C., and the aqueous phase, at a pump rate of 29.9 kg/h and at room temperature, were continuously mixed in a mixing chamber at a system pressure of about 24 bar.

The tetrahydrofuran and some of the water were then removed in a rotary evaporator at a temperature of 65° C. and a pressure of 200 mbar. The dispersion obtained in this manner had a solids content of 17.9% and a particle size of 117 nm.

### Example 2

### Preparation of an Aqueous Dispersion of a Ta Polyester

17.5 g of polybutylene adipate terephthalate (Ecoflex®, BASF AG) were dissolved at room temperature in 250 g of methylene chloride (solvent phase). In a separate vessel, 2 g of sucrose ester (Ryoto® S-1670S) were dissolved at 70° C. in 350 g of deionized water (aqueous phase).

Using a dispersion apparatus (Ultra-Turrax®), the solvent phase was then stirred into the aqueous phase. 100 ml of isopropanol were then added. With cooling, the mixture was then emulsified with the dispersion apparatus (Ultra-Turrax®) for 10 minutes. The crude emulsion obtained in this manner had a solids content of 2.8% and, at a pH of 7.5, a droplet size of 466 nm.

In three passages, this crude emulsion was homogenized further in a high-pressure homogenizer at a pressure of 700 bar. The droplet size was then 339 nm. 2 g of Na dodecyl sulfate were then dissolved in 150 g of deionized water and added to the emulsion. The emulsion was then treated three more times in the high-pressure homogenizer, under the same conditions as above. In this way, the droplet size was reduced to 116 nm.

The methylene chloride and sufficient water were then removed in a rotary evaporator, until the solids content of the dispersion was 29.3%. By dynamic light scattering, the particle size was determined to be 108 nm and the viscosity of the dispersion was determined to be 6 mPas at a shear rate of 50 sec⁻¹.

### Example 3

### Dressing of Seed Using a Commercially Available Seed Dressing Formulation

The seed dressing used was Premis 025 FS® from BASF, a commercially available formulation of the crop protection agent triticonazole.

For dressing, the dressing apparatus (MiniRotostat from Satec) was filled with 2 kg of untreated soybean seed. The dish and the turntable were switched on, and 10 ml of Premis 025 FS® were then added onto the turntable. After the addition, the mixture was mixed for another 20 seconds and the treated seed was then removed and air-dried.

### Example 4

### Dressing of Seed with a Seed Dressing Formulation According to the Invention Comprising an Aqueous Dispersion of a TA Polyester

To produce the seed dressing formulation according to the invention, the aqueous dispersion obtained according to Example 2 was mixed with the same amount of Premis 025 FS® from BASF.

For dressing, the dressing apparatus (MiniRotostat from Satec) was filled with 2 kg of untreated soybean seed. The dish and the turntable were switched on, and 20 ml of the resulting mixture were then added onto the turntable. After the addition, the mixture was mixed for another 20 seconds and the treated seed was then removed and air-dried.

### Example 5

### Examination of the Dusting Behavior

The dressed seed obtained according to Example 3 and Example 4 was used to carry out a dusting test. For this purpose, 250 g of seed were weighed out into a 500 ml glass bottle, and this bottle was turned on a roller stand at 60 rpm for 10 minutes. After this treatment, a dust fraction of 1.0 mg of dust per 100 kg of soybean seed was found for the seed prepared according to Example 3. A lower fraction of dust of 0.4 mg per 100 kg of soybean seed was found for the soybean seed prepared according to Example 4 and based on the seed dressing formulation according to the invention.

### Example 6

### Examination of the Effect on the Germination Rate

To examine the effect of the dressing on the germination rate of the treated soybeans, the germination rate of untreated soybeans was compared to the germination rate of treated soybeans.

The germination rates of the following seed samples were compared:

### Untreated Soybean Seed

Soybean seed treated with the aqueous dispersion prepared according to Example 2 (application rate: 50 g per 100 kg of seed)

Soybean seed treated with the commercially (BASF) available seed dressing formulation REAL 200 FS (application rate: 12.5 g per 100 kg of seed).

(Procedure according to the invention) soybean seed treated with the aqueous Ecoflex® dispersion prepared according to Example 2 (application rate: 50 g per 100 kg of seed) and then treated with the commercially (BASF) available seed dressing formulation REAL 200 FS (application rate: 12.5 g per 100 kg of seed).

In the case of the soybean seed (b) treated with the aqueous Ecoflex® dispersion, the germination rate was found to be similar to that of untreated seed. In contrast, when the treatment was carried out using the commercial seed dressing formulation (c), a considerably slower germination rate was observed. A considerably improved germination rate was observed if there was an additional treatment according to the invention with the aqueous Ecoflex® dispersion (d).

### Example 7

### Examination of the Effect on the Thriftiness of Soybean Plants

To examine the effect of the dressing on the thriftiness, the growth heights of the soybean plants from treated seed were compared to the growth heights of plants from untreated seed.

The thriftiness of soybean plants from the following seed samples was compared:

### Untreated Soybean Seed

Soybean seed treated with the aqueous dispersion prepared according to Example 2 (application rate: 50 g per 100 kg of seed)

Soybean seed treated with the commercially (BASF) available seed dressing formulation REAL 200 FS (application rate: 25 g per 100 kg of seed, active compound triticonazole).

(Procedure according to the invention) soybean seed treated with the aqueous Ecoflex® dispersion prepared according to Example 2 (application rate: 50 g per 100 kg of seed) and then treated with the commercially (BASF) available seed dressing formulation REAL 200 FS (application rate: 25 g per 100 kg of seed).

It was found that the thriftiness of the soybean plants was not affected in any significant manner by treating the seed with aqueous Ecoflex® dispersion. However, when the seed had been treated with a commercial seed dressing formulation (g), a considerably slower plant growth was observed for 20-29 day old plants. This effect is considerably less pronounced when the seed is additionally treated with the aqueous Ecoflex® dispersion (h) (according to the invention). However, for older plants (60 days old), an improved plant growth of the plants from treated seed was observed. This improvement was particularly pronounced for the plants from the seed additionally treated with Ecoflex®).

### Example 8

### Fungicidal Action

When soybean plants from treated and untreated seed and infected with soybean rust (Phakopsora pachirisi) were examined, it was found that infection with soybean rust was reduced considerably by treating the seed. A reduced infection was observed when the seed was additionally treated according to the invention with aqueous Ecoflex® dispersion (application rate 12.5 g/100 kg of seed), at low application rates of the active compound.

At higher application rates, the fungicidal action was not found to be adversely affected by the formulation according to the invention.

1-12. (canceled)

13. A liquid seed dressing formulation comprising a partially aromatic biodegradable polyester, wherein the polyester is a partially aromatic constructed of:
A) an acid component of
a1) 30 to 95 mol % of at least one aliphatic or at least one cycloaliphatic dicarboxylic acid or ester-forming derivatives thereof or mixtures thereof
a2) 5 to 70 mol % of at least one aromatic dicarboxylic acid or its ester-forming derivative or mixtures thereof,
where the mole percentages of components a1) to a2) add up to 100% and B) a diol component of at least one C₂- to C₂-alkanediol or one C₅- to C₁₀-cycloalkanediol or mixtures thereof.

14. The liquid seed dressing formulation of claim 13 further comprising a solvent and at least one agrochemically active compound suitable for dressing seed, where the active compound is present in solid particles having a size between 0.1 μm and 10 μm.

15. The liquid seed dressing formulation of claim 14, further comprising a polylactic acid.

16. The liquid seed dressing formulation of claim 14, wherein the agrochemically active compound is selected from the group consisting of herbicides, safeners, fungicides, insecticides or combinations thereof.

17. A process for preparing the liquid seed dressing formulation of claim 16, which comprises mixing a suspension of an agrochemically active compound suitable for dressing seed, in which the active compound is present in solid particles having a size between 0.1 μm and 10 μm, with a dispersion of the partially aromatic biodegradable polyester.

18. A method for dressing seed, which comprises treating seed with the liquid seed dressing formulation of claim 13.

19. The method of claim 18 further comprising drying the dressed seed.

20. The method of claim 18 further comprising treating the dressed seed with an agrochemical suspension formulation comprising at least one agrochemically active compound suitable for dressing seed, where the active compound is present in solid particles having a size between 0.11 m and 10 μm.

21. The method of claim 20, wherein the seed are soybeans.

22. Seed, dressed with a dispersion of a biodegradable, partially aromatic polyester according to claim 13.

23. A method for regulating the growth of plants, for controlling unwanted vegetation, for controlling unwanted infestation by insects or mites on plants, or for controlling phytopathogenic fungi, which comprises treating seed of useful plants with a formulation according to claim 13.
